(19) United States
(12) Patent Application Publication
(10) Pub. No.: US 2025/0172037 A1
(43) Pub. Date: May 29, 2025

(54) One-use wet discharge air-reduction for a window slit or a door gap

(71) Applicant: Cotes A/S, Viby J (DK)

(72) Inventors: Thomas Rønnow, Barcelona (ES); Rasmus Toftegaard, Mårslet (DK)

(21) Appl. No.: 18/954,606

(22) Filed: Nov. 21, 2024

(30) Foreign Application Priority Data
Nov. 23, 2023 (DK) PA 2023 30345

(51) Int. Cl. E06B 7/02; F24F 1/0358; F24F 7/04

(52) U.S. Cl. CPC E06B 7/02; F24F 1/0358; F24F 7/04; F24F 2203/026; F24F 2203/1036; F24F 2221/20

(57) ABSTRACT

A one-use air-reduction is herein detailed which is suitable for mounting in window slits or door gabs for use in discharging wet air from room dehumidification, without the one-use air-reduction preventing safety devices built into the window or door the one-use air-reduction is installed.

### CROSS REFERENCE TO RELATED APPLICATION

This application claims priority to Danish Patent Application No. PA 2023 30345 filed Nov. 23, 2023, the content of which is incorporated herein by reference in its entirety.

### TECHNICAL FIELD

In the field of building dehumidification there is suggested a one-use air-reduction for wet discharge air from an adsorption/desorption type dehumidifier which is simple to install with existing windows or doors and does not prevent inbuild safety elements in the window or door carrying the air-reduction from functioning.

### BACKGROUND

Due to the increased polarization of the weather due to climate changes many regions of the globe have experienced a rapid increase in heavy rain while many other regions of Earth now suffer severe draughts and/or the absence of seasonal rain.

In countries such as Denmark, significantly increased precipitation has been registered over the last decade, an increased precipitation for which the drainage and sewer systems locally in place have shown inadequate to contain the precipitation from causing spillage or outright flooding into buildings, in particular basements and ground levels of houses and like buildings.

To restore building functionality after a spill or flooding event, and after visible water has been removed by pumping or other like means, the building parts subjected to the water typically contain too much residual moisture to be habitable or to be in a state suitable for rebuilding. Consequently, it is necessary to dehumidify the building and its parts prior to restoration and/or rehabitation.

Typically, this is done by extracting humidity from the inside air of the building and relying on water desorption from the building and its parts to the inside air as an intermediate process step, prior to water removal. In the art, this is primarily done using air-cooling condensation units (air-con units) while other known types of dehumidifiers, are less prevalent, despite the recognized drawbacks in terms of energy efficiency and drying efficacy of condensation units, particularly at location temperatures below 15-20° C. such as one may find in a flooded basement.

The underlying reason for this otherwise contradictory choice is the necessarily temporary, but urgent need for dehumidification after a flooding event, which demands rapid deployment of dehumidifiers and subsequent removal of the same after use. And often, particularly after torrential rain events, access to enough dehumidifiers in a local housing area can be strongly limited as more than one building in the vicinity will need dehumidification.

A further problem for dehumidification is related to the air-circulation volumes available for dehumidification. Most buildings are not designed for regular air circulation with the exterior, such as most family houses, bungalows, etc. but also most small-scale industry and office buildings, and in particular family houses and like buildings having basements, and dehumidification therefore require a significant air-pumping effort. However, air-pumping must also be tailored to match the dehumidifier's removal capacity for water, otherwise energy is lost to circulating excess air without drying. Often e.g., when using condensation units, units are installed which do not have sufficient air-circulation capacity for the given location as the pumping capacity is matched to the removal efficiency of the condensation unit, or the unit has had its efficiency reduced due to resonance with other condensation units at same the location, such that the intake air to the condensation unit effectively is the outlet air from other units, whereby the dehumidification efficacy of the units is significantly reduced.

However, remediating the problem has proven difficult, one problem being, that other dehumidifier types, such as e.g., adsorption/desorption type dehumidifiers, which have better air-circulation capacities (as the higher drying capacity compared to condensation units permits the use of more powerful pumps), the manner in which such other dehumidifier types' of function often require more complex local installation than what can be done at short notice. However, if such installation limitations can be overcome, adsorption/desorption type dehumidifiers typically weigh less pr. weight of water removed and are therefore easier to handle or carry, e.g., if the water spillage has occurred in a basement with limited access for lifting and transportation aids.

E.g., most adsorption/desorption type dehumidifiers work by concentrating the water content of an air stream, the exhaust air, and subsequently releasing the water rich exhaust air to the surrounding environment. However, this creates the need for air replenishment to the location of use and the need for a path for exhaust air to be released to the surrounding environment in a manner that does not cause re-humidification at the location of use of the dehumidifier, two requirements that often is not readily procurable.

The present invention relates to improvements to adsorption/desorption dehumidifiers, whereby some of the drawbacks to installation of dehumidifiers requiring air exchange with the exterior, such as adsorption/desorption dehumidifiers, can at least partially be alleviated.

Currently, to install e.g., an adsorption/desorption dehumidifier at a location of use, it is necessary to provide an exit for wet discharge air. This can, in a simple and rapid manner, be done e.g., in a basement, by opening a window and provide a conduit for wet air from the dehumidifier to the exterior. However, this is not particularly advantageous, as the basement now is open for the duration of the dehumidification process to access from undesired others, and hence this configuration requires simultaneous surveillance for avoiding such undesired access by others.

Therefore, it is common to remove windowpanes and to install conduits for exit air in fixtures attached to the windows at the prior positions of the windowpanes. However, this process is both costly and time consuming, particularly if many houses in the same neighborhood have suffered flooding from a local event of torrential rain.

Other solutions rely on air exhaust conduits which can be mounted in the windows, such as the air exhaust conduits or various fixtures detailed e.g., in AT 513167 A1, DE 102018007113 A1, DE 19533226 A1, DE 102006024803 A1, DE 102020113669 A1, CN 2298460 Y, EP 3907438 A1, or e.g., WO 2017202472 A1. These documents of the prior art detail air exhaust conduits in accordance with the introductory part of claim 1. In general, however, the solutions in the prior art fail to solve the coexisting problem of preventing unwanted access to the location of dehumidification, or for such solutions (e.g., EP 3907438 A1 or WO 2017202472 A1) that can prevent such unwanted access, would still require a measure of permanent mounting in the window, which is difficult to achieve without causing permanent damage (such as by fastening with screws to the windows frame), and therefore is generally unacceptable for provisional dehumidification measures.

The present inventors now propose a one-use wet-air outlet air-reduction for mounting in a window slit or door gap and connecting to an exhaust conduit from an air-conditioner, in particular a dehumidifier, and more particular an adsorption/desorption dehumidifier, which is also suitable for use with modern windows or doors containing installed safety measures for allowing a slight opening of the window or door while otherwise preventing breaking and entering.

While reductions for reducing the cross-section of an air conduit (and other conduits of fluids) are well known in the art, such reductions in general assume that the reduction can be installed without being hindered by other building parts at the location of installation. The present air-reduction has been designed for use, where in general this cannot be assumed.

### BRIEF DESCRIPTION OF THE DRAWINGS

FIG. 1: A generalized embodiment of the present air-reduction.

FIG. 2: A preferred embodiment of the present air-reduction.

FIG. 3: A preferred embodiment of the present air-reduction.

FIG. 4: A kit of parts according to the invention.

It is to be understood, that the embodiments shown in the figures are for illustration of the present invention and cannot be construed as being limiting on the present invention. Unless otherwise indicated, the drawings are intended to be read (e.g., cross-hatching, arrangement of parts, proportion, degree, etc.) together with the specification, and are to be considered a portion of the entire written description of this disclosure.

### DETAILED DESCRIPTION

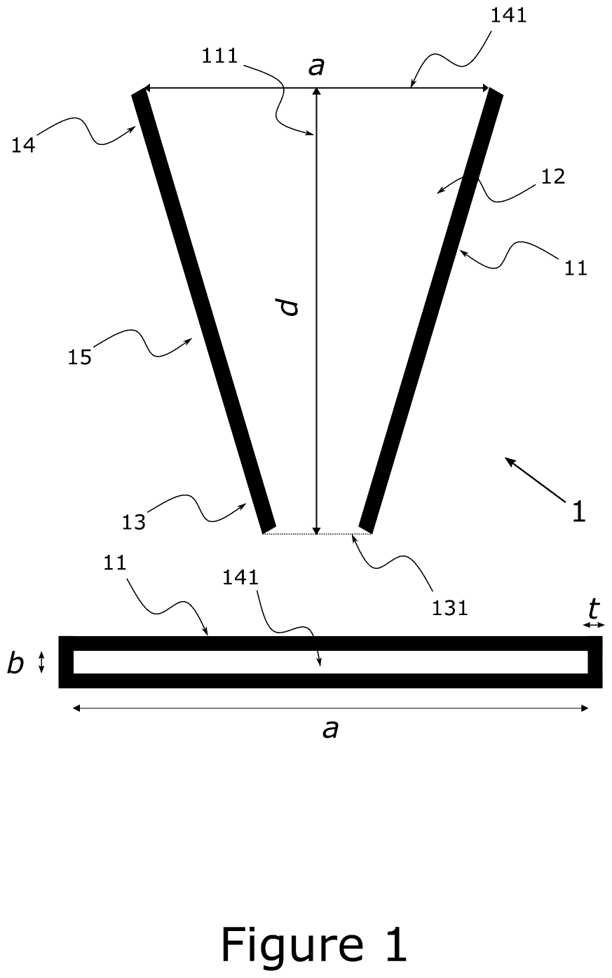

In accordance with the present invention (c.f. FIG. 1), there is herein detailed a one-use air-reduction (1) for connecting to an air conduit (2), the one-use air-reduction (1) comprising an envelope (11) manufactured from a plastic foil of foil thickness (t) and defining an envelope interior (12) open for air passage between an air inlet (131) having an inlet area (I), and an air outlet (141) having an outlet area (O), and defining in use an air flow direction from the air inlet (131) to the air outlet (141), the air inlet (131) and the air outlet (141) arranged apart in the envelope (11) perpendicular to the air flow direction with respect to an envelope axis (111) defined by the shortest distance (d) measured along the envelope axis (111) from an invariant center of the inlet area (I) to an invariant center of the outlet area (O); the envelope (11) comprising:
an air inlet section (13) comprising the air inlet (131) and adapted for permitting attachment of the envelope (1) to an air conduit (2) for, in use, permitting a flow of air passage from the air conduit (2) through the envelope interior (12) to the air outlet (141);
an air outlet section (14) comprising the air outlet (141); and
an expansion section (15) arranged between the air conduit connector section (13) and the air outlet section (14); and
wherein:
the outlet area (O) is defined by an opening length (a) and an opening width (b) having a ratio of length to width from a/b=150 to a/b=25; and
the foil thickness (t) is from 0.05 mm to 1 mm.

The concept behind the present invention and the suggestion to use a one-use air-reduction (1) and operatively connect it via an air conduit (2) to a dehumidifier (3) is based on the present inventors' observation that most modern windows and doors, even when opened only to a break-in safe slit between windowsill and sash, or doorframe and door, and locked in position e.g., using safety grips, still presents an opening which is large enough in cross-section to permit sufficient airflow for using dehumidifiers, such as adsorption/desorption dehumidifiers, which rely on wet air discharge for their operation, if only the air conduit transporting the wet discharge air can be placed across the window slit or door gap.

The present one-use air-reduction (1) solves this problem in a simple manner by having an expansion section (15) arranged between the air inlet section (13) and the air outlet section (14) such that the air outlet (141) can have an elongated geometry commensurate with the geometry of a window slit formed between windowsill and sash, or door gap formed between doorframe and door, even when the window or door is locked in a safety position.

In the text below, the use of the present air-reduction is detailed in the context of windows, however, as can be easily understood, this is only for simplification of the presentation, as the installation and use of the air-reduction is identical when installed in a door gap between door and doorframe.

For using the one-use air-reduction (1), the air-reduction (1) is placed with the air outlet (14) outside the building to be dehumidified and the air inlet (13) is placed inside the same building such that the air-reduction (1) traverses the window inside the window slit formed by the open window.

The window can now, after the placement of the air-reduction (1) in the window slit be returned to a safety position and locked in that position, without preventing the discharge of wet discharge air via the air-reduction (1) to the surrounding environment, after the air-reduction (1) has been attached at the air inlet section (13) to an air conduit (2) leading wet discharge air away from a dehumidifier (3).

An advantage of the present invention is, that even if the safety locking mechanisms of the window overlaps with the envelope (11) of the air-reduction (1), the envelope (11) can simply be ruptured at such overlapping positions, permitting the normal operation of the window and/or the safety locking mechanisms of the window, but without interfering with the safe discharge of the wet air from the dehumidifier (3) through the air-reduction (1) as, compared with the size of the outlet area (O), any rupture of the envelope (11) will be inconsequential for the flow of wet discharge air to the surrounding environment through the air outlet (141) of the air-reduction (1).

To ensure this effect, however, the foil thickness (t) of the envelope (11) cannot be too large, in particular since the thickness a safety mechanism has to rupture for proper operation is twice the thickness (t). For working the present invention optimally, the plastic foil used should be waterproof and gas-diffusion tight, although it is not absolute. Not using a waterproof and gas-diffusion tight plastic foil merely lowers the efficacy of the dehumidification, but does not impede it, as the wet discharge air will only normal operation conditions pass the air-reduction (1) of the invention faster than a minor loss of humidity by diffusion through the plastic foil. The present inventors have achieved good results in test using vapor barrier PE-foil of 0.2 mm thickness, such as vapor barrier foil for roof construction from DAFA Denmark, having a water tightness sd-value of ≥92 m according to the manufacturer.

Preferred, the foil thickness (t) is from 0.05 mm to 0.5 mm, from 0.05 to 0.4 mm, or from 0.05 mm to 0.3 mm, but preferred from 0.05 mm to 0.25 mm, from 0.05 mm to 0.2 mm or from 0.05 mm to 0.15 mm, and more preferred from 0.05 mm to 0.125 mm, from 0.05 mm to 0.1 mm, or most preferred from 0.05 mm to 0.075 mm. Essential by the selection of a specific thickness of the plastic foil is, that the specific plastic foil selected can withstand the air pressure of the discharged flow of wet air from the dehumidifier in use. In general, as the air-reduction (1) is for one-use, the thinner the plastic foil, the lower the production cost of the air-reduction (1) will usually be. However, for very thin foils (i.e., below 0.05 mm thickness), foil prices typically increase as the plastic quality required for withstanding pressurized flow typically increases as well. The lower limit of 0.05 mm thickness is therefore a reasonable compromise in today's market between cost and function of the envelope (11) made from a plastic foil.

For preventing pressure buildup in the air-reduction (1), the outlet area (O) preferably should be at least the same area as the inlet area (I); however, to compensate for pressure loss across the air-reduction (1), the outlet area (O) preferably is larger than the inlet area (I), such as 20% larger, 10% larger or 5% larger than the inlet area (I). The present inventors have tested the present invention with air conduits of Ø80 mm and Ø100 mm corresponding respectively to inlet areas (I) of approximately 50 cm² and 80 cm² and have achieved good flow results across the air-reduction (1) when the outlet areas (O) in the two examples were about 10% larger than the inlet areas (I).

For a window slit of approximately 1 cm between windowsill and sash (corresponding to the maximum possible opening width (b) achievable in the tests), tests were conducted with an opening length (a) of respectively 60 cm and 100 cm, thus giving a ratio of length to width in the two examples of a/b=100 and a/b=60.

Typically, the opening width (b) should not be larger than 4 cm and the opening length (a) adjusted to match the opening width (b) such that a suitable ratio of length to width in accordance with the invention is achieved in an assembled air-reduction (1). Preferred, the opening width (b) is 4 cm, 3.5 cm, 3 cm, 2.5 cm, or 2 cm, but more preferred the opening width (b) is 1.75 cm, 1.5 cm, 1.25 cm, 1 cm, or 0.75 cm.

In FIG. 1, the air outlet (141) is shown as forming an essentially rectangular opening, wherein the opening width (b) and the opening length (a) correspond to respectively the width and the length of the rectangular opening showed in the figure. In the figure, this has been done in order to illustrate better the opening width (b) and the opening length (a), and in most embodiments, the air outlet (141) will deviate from a rectangular shape, rather forming an ellipsoidal or like shape. The benefit of an ellipsoidal shape is both for avoiding sharp corners forming in the air-reduction (1) which could rupture more easily when pressurized, and for ease of manufacture, since the present air-reduction (1) can be manufactured simply by thermowelding two sheets of plastic foil together along the edges of the sheets that are in parallel to the envelope axis (111) defining the aforementioned distance (d). In such cases, the opening length (a) corresponds to the longest cross-section of the air outlet (141) and the opening width (b) corresponds to the longest cross-section of the outlet (141) perpendicular to the opening length (a), when the air-reduction (1) is in use. It is a benefit of the present construction that when the air-reduction (1) of the invention is manufactured by thermowelding of the two sheets along the mentioned edges, the air outlet (14) the sheets at the air outlet (14) will still touch, and the air-reduction (1) can therefore pack more closely during shipping, but when pressurized will assume the desired shape of the air outlet (14).

As detailed, the air inlet (131) and the air outlet (141) are arranged in the air-reduction (1) with respect to each other apart in the envelope (11) perpendicular to the air flow direction at a distance (d) measured along the air flow direction from an invariant center of the inlet area (I) to an invariant center of the outlet area (O). Since, usually, the air inlet (131) will be essentially circular for optimally receiving a circular conduit as commonly used in the art, and since the air outlet (141) as shown in FIG. 1 is essentially rectangular or ellipsoidal, the respective invariant centers of the air inlet (131) and air outlet (141) will correspond for the air inlet (131) to the center of the circular conduit and for the air outlet (141) to the point where the diagonals of the air outlet (141) crosses. By the present definition of the positions of the air in- and outlets their relative position stays unchanged even if the expansion section (15) is e.g., curved, such as could be the case if the expansion section (15) was adapted for fitting into a window slit formed by a windowsill and sash in a vertically opened window rather than into a horizontally opened window. Accordingly, by the relative positions of air inlet (131) and air outlet (141) to each other, flow through the present air-reduction (1) remains optimized independent of the geometry of the expansion section (15).

In most embodiment of the present invention, it is intended that the envelope (11) at the expansion section (15) forms an angle to the aforementioned envelope axis (111) of from 30° to 60°, in most embodiments from 40° to 50°, or more frequently 45°. Thereby the expansion section (15) most effectively distributes the wet discharge air across the envelope interior (12) for optimal use of the entire outlet area (O).

A particular advantage of the air-reduction (1) of the present invention is that it can rapidly be mounted for use on an air conduit (2) by placing the air inlet section (13) around the opening of the air conduit (2) and securing the air-reduction (1) to the air conduit (2) e.g., by using cable ties or like measures. As such it follows that the air inlet section (13) must always be large enough to accommodate the air conduit (2) inside the air inlet section (13) but is otherwise not restricted in size due to the flexibility of the plastic foil from which the envelope (11) is manufactured.

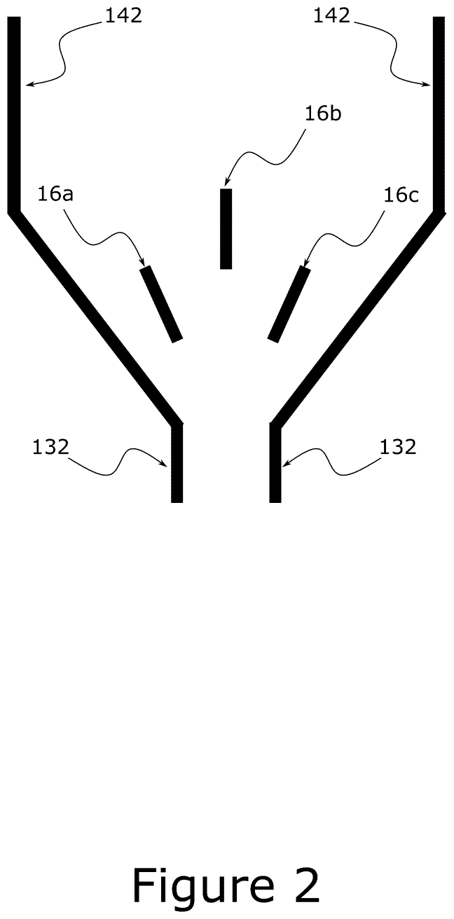

In FIG. 2 there is detailed a preferred embodiment of the present air-reduction (1) wherein one or more flow guides (16a-c) are arranged inside the envelope interior (12), preferably in a part of the envelope interior (12) comprised in the expansion section (15) of the envelope (11).

Thereby improvements to the wet discharge air flow during use of the air-reduction (1) can be achieved and at the same time the possibility of filling rupture of the plastic foil is minimized when the foil is first pressurized at the start of dehumidification. At the same time, it is prevented that the envelope (11) expands, if the foil is thin, much like a balloon, or, if the foil is shape-retaining under the applied pressure, inwards towards the air source.

For manufacturing the flow guides (16a-c), the two sides of the envelope (11) made from the plastic foil can simply be thermowelded together, thereby creating the desired flow guides (16a-c). In the example shown above, three flow guides are used, however this is not limiting. The actual number of flow guides rather depends on the pressure used to expel the wet air from the dehumidifier and is adjustable to the local need of a user, e.g., by selecting an air-reduction (1) of the invention with e.g., 2, 4, or 5 flow guides, if the use-situation so requires.

Further in FIG. 2 there is detailed embodiments of the present air-reduction (1), wherein at least one of either of the air inlet section (13) and/or the air outlet section (14) comprises a respective inlet region (132) or outlet region (142) wherein air flow is parallel to the envelope axis (111). In case of the inlet section (13) the inlet region (132) in general will be adapted at manufacture to match a diameter of the air conduit (2) it is intended to be connected to for obtaining an improved air seal between the inlet section (13) and the air conduit (2), whereas for the respective outlet region (142) of the outlet section (14), the construction of the outlet region (142) permits uniform distribution of the wet discharge air across an opened window, wherein the air-reduction (1) of the invention has been mounted.

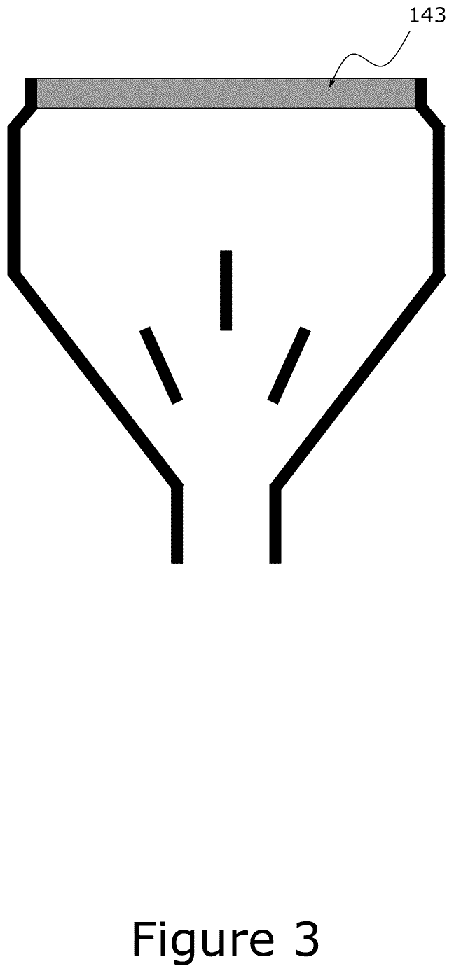

In FIG. 3 is detailed a particularly preferred embodiment of the present one-use air-reduction (1), wherein the air outlet (141) is defined by a filter (143), preferably a filter (143) manufactured from a filtering foam, more preferably a filter (143) manufactured from a polyether-based filtering foam.

The present inventors have found that in some situations the one-use air-reduction (1) can move backwards towards the dehumidifier in use. Providing a filter, such as a low-cost polyether-based filtering foam, e.g., a PPI-filter foam from DAFA A/S of Denmark, prevents the air-reduction (1) of the present invention backwards movement as the pressurized discharge air will expand the filter to a size larger than a window slit of the type for which the air-reduction (1) of the invention is intended for installation.

In an embodiment of the one-use air-reduction (1) (not shown), the one-use air-reduction (1) comprises more than one air-inlet section such that multiple air conduits (and dehumidifiers) can use the same one-use air-reduction (1). Conventionally, this can be constructed with a several entrances to a single inlet section (13) having a single air-inlet (131) to the envelope interior (12) or a plurality of inlet sections, each having an air-inlet to the envelope interior. Normally, however, a reusable connector conduit will be mounted in the inlet section (13) and the more than one conduit (2) connected to the reusable unit. Such embodiments are e.g., useful where more than one room is to be dehumidified at the same time but not all of the rooms are equipped with windows for mounting a one-use air-reduction (1) of the invention.

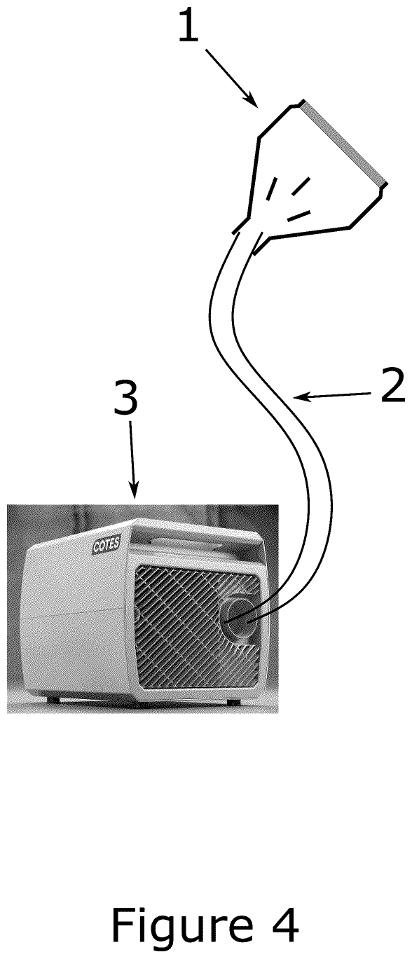

In accordance with the present invention (c.f., FIG. 4), there is further detailed an air conduit (2) attached at an end (21) of the air conduit (2) to the inlet section (13) of a one-use air-reduction (1) according to any of the herein detailed embodiments, such that a flow of air can traverse the air conduit (2) and the attached one-use air-reduction (1) and exit the one-use air-reduction (1) at the air outlet (141) of the one-use air-reduction (1) of the invention.

In accordance with the present invention (c.f., FIG. 4) there is further detailed a dehumidifier (3) operatively connected to a one-use air-reduction (1) according to any of the herein detailed embodiments for permitting a flow of air expulsed by the dehumidifier (3) to enter the one-use air-reduction (1) at the air inlet (131) of the one-use air-reduction (1) and exit the one-use air-reduction (1) at the air outlet (141). In preferred embodiments thereof, the dehumidifier (3) is an adsorption/desorption dehumidifier (3), or, more preferably, wherein the dehumidifier (3) is a rotating desiccant wheel dehumidifier (3).

In accordance with the present invention (c.f., FIG. 4), there is further detailed a kit of parts at least comprising an one-use air-reduction (1) according to any of the embodiments detailed herein, a dehumidifier (3), and an air conduit (2) suitable for operatively connecting a wet air discharge outlet on the dehumidifier (3) to the inlet section (13) of the one-use air-reduction (1) for discharge of wet discharge air from the dehumidifier (3) through the air conduit (2) and the one-use air-reduction (1). In preferred embodiments thereof, the dehumidifier (3) is an adsorption/desorption dehumidifier (3), or, more preferably, wherein the dehumidifier (3) is a rotating desiccant wheel dehumidifier (3). In an embodiment thereof, the kit of parts further comprises cable ties.

### Closing Comments

Although the present invention has been described in detail for purpose of illustration, it is understood that such detail is solely for that purpose, and variations can be made therein by those skilled in the art in practicing the claimed subject matter, from a study of the drawings, the disclosure, and the appended claims.

The term “comprising” as used in the claims does not exclude other elements or steps. The indefinite article “a” or “an” as used in the claims does not exclude a plurality. A unit may fulfill the functions of several means recited in the claims. A reference sign used in a claim shall not be construed as limiting the scope.

1-8. (canceled)

9. A one-use air-reduction for connecting to an air conduit, said one-use air-reduction comprising an envelope manufactured from a plastic foil of foil thickness and defining an envelope interior open for air passage between an air inlet having an inlet area, and an air outlet having an outlet area, and defining in use an air flow direction from said air inlet to said air outlet, said air inlet and said air outlet arranged apart in said envelope perpendicular to said air flow direction with respect to an envelope axis defined by the shortest distance measured along said envelope axis from an invariant center of said inlet area to an invariant center of said outlet area; said envelope comprising:
an air inlet section comprising said air inlet and adapted for permitting attachment of said envelope to said air conduit for, in use, permitting said flow of air passage from said air conduit through said envelope interior to said air outlet;
an air outlet section comprising said air outlet; and
an expansion section arranged between said air conduit connector section and said air outlet section; and
wherein:
said outlet area is defined by an opening length and an opening width having a ratio of length to width from a/b=150 to a/b=25; and
said foil thickness is from 0.1 mm to 1 mm.

10. A one-use air-reduction according to claim 9, wherein one or more flow guides are arranged inside said envelope interior.

11. A one-use air-reduction according to claim 10, wherein said one or more flow guides are arranged inside said envelope interior in a part of said envelope interior comprised in said expansion section of said envelope.

12. A one-use air-reduction according to claim 9, wherein at least one of either of said air inlet section and/or said air outlet section comprises a respective inlet region or outlet region wherein air flow is parallel to said envelope axis.

13. A one-use air-reduction according to claim 9, wherein said air outlet is defined by a filter.

14. A one-use air-reduction according to claim 13, wherein said filter is manufactured from a filtering foam.

15. A one-use air-reduction according to claim 14, wherein said filtering foam is polyether-based filtering foam.

16. A one-use air-reduction according to claim 9, wherein said one-use air-reduction comprises more than one air-inlet section.

17. An air conduit attached at an end of said air conduit to the inlet section of a one-use air-reduction according to claim 9, such that a flow of air can traverse said air conduit and said attached one-use air-reduction and exit said one-use air-reduction at the air outlet of said one-use air-reduction.

18. A dehumidifier operatively connected to a one-use air-reduction according to claim 9, for permitting a flow of air expulsed by the dehumidifier to enter said one-use air-reduction at the air inlet of said one-use air-reduction and exit said one-use air-reduction at the air outlet.

19. A dehumidifier according to claim 18, wherein said dehumidifier is an adsorption/desorption dehumidifier.

20. A dehumidifier according to claim 18, wherein said dehumidifier is a rotating desiccant wheel dehumidifier.

21. A kit of parts at least comprising a one-use air-reduction according to claim 9, a dehumidifier, and an air conduit suitable for operatively connecting a wet air discharge outlet on said dehumidifier to said inlet section of said one-use air-reduction.

22. A kit of parts according to claim 21, wherein said dehumidifier is an adsorption/desorption dehumidifier.

23. A kit of parts according to claim 21, wherein said dehumidifier is a rotating desiccant wheel dehumidifier.
